(19) United States
(12) Patent Application Publication
(10) Pub. No.: US 2024/0374351 A1
(43) Pub. Date: Nov. 14, 2024

(54) HYBRID ORTHODONTIC APPLIANCE

(71) Applicant: FIRE GROUP IP, LLC, Centreville, VA (US)

(72) Inventor: Howard Ngo, Centreville, VA (US)

(73) Assignee: FIRE GROUP IP, LLC, Centreville, VA (US)

(21) Appl. No.: 18/638,098

(22) Filed: Apr. 17, 2024

Related U.S. Application Data
(60) Provisional application No. 63/501,643, filed on May 11, 2023.

(51) Int. Cl. A61C 7/08; A61C 7/28

(52) U.S. Cl. CPC A61C 7/08; A61C 7/28

(57) ABSTRACT

A hybrid orthodontic appliance is for repositioning a patient's teeth, the hybrid orthodontic appliance includes at least one tray and a brace. Each of the at least one tray includes a main body and a connecting portion. The main body includes a tooth receiving cavity shaped to receive only a portion of the patient's teeth, an interior surface facing towards the tooth receiving cavity, and an exterior surface opposite to the interior surface. The connecting portion is located at the exterior surface of the main body. The brace is detachably connected to the connecting portion.

### BACKGROUND

### Technical Field

The disclosure relates to an orthodontic appliance, and in particular to a hybrid orthodontic appliance.

### Description of Related Art

The traditional methods of teeth movement and/or osseous changes/osseous remodeling are based on forces, pressure and moments placed onto/into appliance(s)/equipment(s)/instrument(s)/hardware(s) (wires and/or brackets with or without attachments with or without rubber band(s)). With the correct amount of pressure/force placed upon the appliance/hardware, it would result in a specific movement and/or osseous changes/osseous remodeling. These were the traditional methods of orthodontics, which require the clinician(s)/doctor(s)/support staff(s)/etc. to monitor. These methods are very successful but have drawbacks, including hygiene issues, increase breakdown of the enamel (demineralization/decay) due to difficulty of maintaining proper hygiene, trauma to oral tissue, poking wires, sharp edges, size limitations, space limitations within the oral cavity, esthetic concerns, etc.

The development and research of clear aligners/tray helped to alleviate some of these issues. With clear aligners, the desired movement is prescribed and integrated into the aligners themselves via wells, attachment housings or button holders, on the internal surface of the clear aligner. Placing the attachments/buttons on the natural tooth/teeth structure, coupled with the clear aligners and prescribed wells, attachment housings or button holders on the internal surface of the clear aligners, created the force(s)/pressure(s)/moments(s) to create osseous changes/osseous remodeling, which would then result in tooth/teeth movement.

However, the major challenge with clear aligners is the ability to effectively and efficiently upright teeth, translate teeth rather than tipping, properly align roots efficiently, etc. Clear aligners are very effective if they have full arch stabilization with no missing teeth. With missing dentition, there is a high chance that tooth/teeth are tipped and/or malpositioned/rotated, creating undercuts and preventing poor model impressions and/or scans, which will result in poor tray seating.

Due to this issue, it is very likely that the movement will not be tracked at some point in the treatment, and new impressions or scans will be required to reset the treatment. This is usually the case for most clear aligner treatments to achieve the proper outcome. Many treated cases will require a minimum of two impressions or scans, while others can require more. It has always been a challenge with the connectors due to the missing tooth/teeth (pontic spaces) on the clear aligners. The connector is a part of the clear aligners corresponding to the missing tooth. The force(s)/pressure(s)/moments(s) created from another part of the clear aligners which is located at one side of the connector is difficult to transfer to the other part of the clear aligners which is located at the other side of the connector. Hence, the connectors in the clear aligners result in weakness of the trays, point(s) of failure, point(s) of poor seating, undercuts due to the angulation, point(s) of flexibility, poor rigidity, poor cross arch stabilization, consistency of tray fabrication, expansion/compression of trays due to active tooth/teeth movement/upright/expansion, etc. Because of these factors clear aligners are poor choices for molar uprighting.

Regardless, a good number of patients are choosing clear aligners due to the ease of wearing the trays as well as prioritizing esthetics over function of the malposition tooth/teeth, which could result in potential issues in the future. Not correcting these issues appropriately could result in poor contacts, poor occlusion, food traps, periodontal pocketing, bone loss and even tooth/teeth loss. Compromises in treatment outcomes are present when faced with these concerns, versus the traditional wire(s)/bracket(s) which can correct the issue in an appropriate time frame.

### SUMMARY

The disclosure provides a hybrid orthodontic appliance, which can improve on existing ideas and methods to create better and more effective teeth movement within the dental and medical field.

A hybrid orthodontic appliance according to an aspect of the disclosure is for repositioning a patient's teeth, the hybrid orthodontic appliance includes at least one tray and a brace. Each of the at least one tray includes a main body and a connecting portion. The main body includes a tooth receiving cavity shaped to receive only a portion of the patient's teeth, an interior surface facing towards the tooth receiving cavity, and an exterior surface opposite to the interior surface. The connecting portion is located at the exterior surface of the main body. The brace is detachably connected to the connecting portion.

In an embodiment of the disclosure, the brace includes a first member and a second member connected to each other, the first member is for being fixed to one of the patient's teeth which is close to the portion, and the second member extends to the connecting portion and detachably connected to the connecting portion.

In an embodiment of the disclosure, the first member of the brace includes a bracket, and the second member of the brace includes a tube, a sleeve, a hook, a wire, a band, a coil, a spring, a chain or an elastic.

In an embodiment of the disclosure, the at least one tray includes two trays, the brace includes two ends opposite to each other, the brace is located between the two trays, and each of the two ends is connected to the connecting portion of the corresponding tray.

In an embodiment of the disclosure, the brace includes a wire, a tube, a sleeve, a band, a coil, a spring, a chain, a hook or an elastic.

In an embodiment of the disclosure, the main body includes a well sunken from the interior surface for housing an attachment which is adapted to attach to one of the portion of the patient's teeth.

In an embodiment of the disclosure, the connecting portion and the main body are integrated.

In an embodiment of the disclosure, the connecting portion includes a hook, an engaging member, a hole or a clip.

A hybrid orthodontic appliance according to an aspect of the disclosure is for repositioning a patient's teeth, the orthodontic appliance includes a tray and a brace. The tray includes a main body and a connecting portion. The main body includes a tooth receiving cavity shaped to receive only a portion of the patient's teeth. The connecting portion is located at an exterior surface of the main body. The brace is for being fixed to one of the patient's teeth which is close to the portion, the brace extends to the connecting portion and detachably connected to the connecting portion.

In an embodiment of the disclosure, the brace includes a first member and a second member detachably connected to each other, the first member is fix to the one of the patient's teeth, and the second member extends to the connecting portion and detachably connected to the connecting portion.

In an embodiment of the disclosure, the first member of the brace includes a bracket, and the second member of the brace includes a tube, a sleeve, a hook, a wire, a band, a coil, a spring, a chain or an elastic.

In an embodiment of the disclosure, the main body includes a well sunken from an interior surface of the main body for housing an attachment which is adapted to attach to one of the portion of the patient's teeth.

In an embodiment of the disclosure, the connecting portion and the main body are integrated.

In an embodiment of the disclosure, the connecting portion includes a hook, an engaging member, a hole or a clip.

A hybrid orthodontic appliance according to an aspect of the disclosure is for repositioning a patient's teeth, the orthodontic appliance includes a plurality of trays and at least one brace. The trays are separated from each other. Each of the trays includes a main body and a connecting portion. The main body includes a tooth receiving cavity shaped to receive only a portion of the patient's teeth. The connecting portion is located at an exterior surface of the main body. Each of the at least one brace includes two ends opposite to each other, each of the at least one brace is located between two adjacent trays of the trays, and each of the two ends of the brace is connected to the connecting portion of the corresponding tray.

In an embodiment of the disclosure, the brace includes a wire, a tube, a sleeve, a band, a coil, a spring, a chain, a hook or an elastic.

In an embodiment of the disclosure, the connecting portion and the main body are integrated.

In an embodiment of the disclosure, the connecting portion includes a hook, an engaging member, a hole or a clip.

In an embodiment of the disclosure, the main body includes a well sunken from an interior surface of the main body for housing an attachment which is adapted to attach to one of the portion of the patient's teeth.

In an embodiment of the disclosure, the trays are transparent, and a material of the trays is different from a material of the at least one brace.

In summary, a hybrid orthodontic appliance according to the embodiments of the disclosure incorporates at least one tray and a brace. The connecting portion of the tray is located at the exterior surface of the main body. The brace is detachably connected to the connecting portion of the tray. In a hybrid orthodontic appliance according to the embodiments of the disclosure, the brace may be fixed to one of the patient's teeth which is close to the portion of the patient's teeth received by the tooth receiving cavity of the tray, and the brace extends to the connecting portion and detachably connected to the connecting portion of the tray. In a hybrid orthodontic appliance according to the embodiments of the disclosure, the brace may be located between two adjacent trays, and each of the two ends of the brace is connected to the connecting portion of the corresponding tray. That is, the two adjacent trays are connected by the brace, and the brace is connected to the trays instead of the actual tooth/enamel itself. Therefore, in the hybrid orthodontic appliances according to the embodiments of the disclosure above, the brace can provide or transfer the forces, pressure and/or moments to the tray or the trays, such that more stable tooth/teeth movement can be provided. In addition, the tray or the trays can be taken off to ensure proper hygiene, then place it/them back on to ensure proper teeth movement and outcome. The hybrid orthodontic appliance can provide the advantages of both the tray and the brace so as to create better and more effective teeth movement on the premise of providing user convenience and comfort.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a schematic view of a hybrid orthodontic appliance according to an embodiment of the disclosure not fully worn on teeth yet.

FIG. 1B is the hybrid orthodontic appliance of FIG. 1A worn on the teeth.

FIG. 2A is a schematic view of a hybrid orthodontic appliance according to another embodiment of the disclosure not worn on teeth yet.

FIG. 2B is the trays of the hybrid orthodontic appliance of FIG. 2A worn on the teeth.

FIG. 2C is the brace connected to the trays of the hybrid orthodontic appliance of FIG. 2B

FIG. 3 is a schematic view of a hybrid orthodontic appliance according to another embodiment of the disclosure and teeth.

FIG. 4 is a schematic view of a hybrid orthodontic appliance according to another embodiment of the disclosure and teeth.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

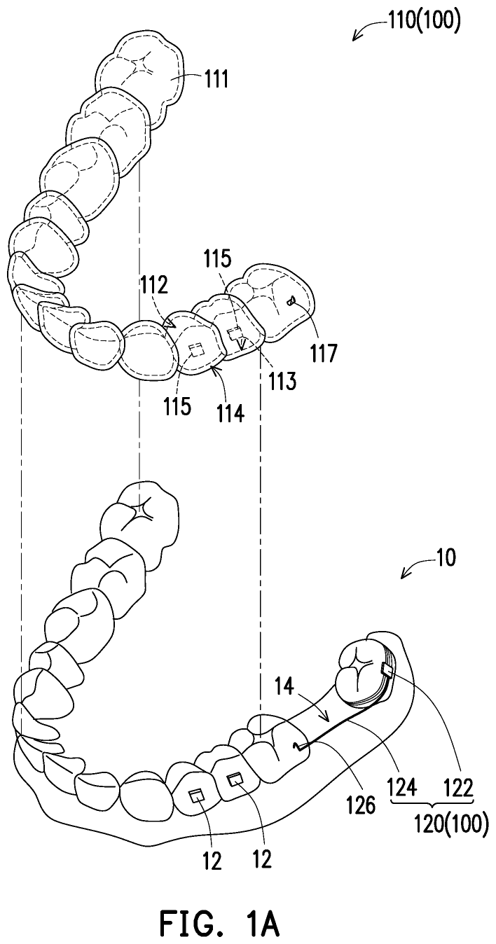

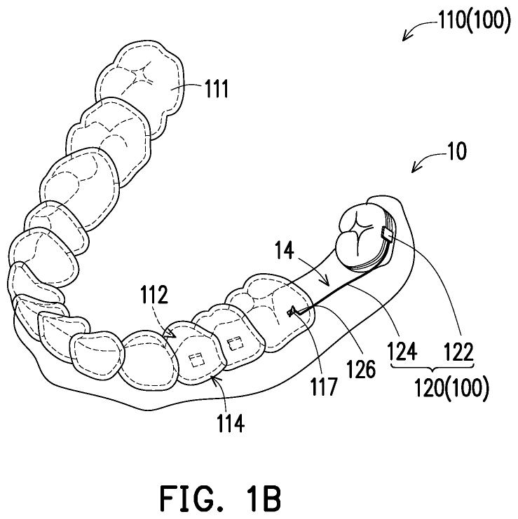

FIG. 1A is a schematic view of a hybrid orthodontic appliance according to an embodiment of the disclosure not fully worn on teeth yet. FIG. 1B is the hybrid orthodontic appliance of FIG. 1A worn on the teeth. Referring to FIG. 1A and FIG. 1B, in the embodiment, a hybrid orthodontic appliance 100 for repositioning a patient's teeth 10 is provided. The hybrid orthodontic appliance 100 includes at least one tray 110 and a brace 120. In the embodiment, a number of the at least one tray 110 is one, but it is not limited thereto.

The tray 110 includes a main body 111 and a connecting portion 117. The main body 111 includes a tooth receiving cavity 112, an interior surface 113 and an exterior surface 114. The interior surface 113 faces towards the tooth receiving cavity 112, and an exterior surface 114 is opposite to the interior surface 113. The tooth receiving cavity 112 is shaped to receive only a portion of the patient's teeth 10.

In the embodiment, the second tooth from the far right in FIG. 1A is missing. The main body 111 of the tray 110 does not cover the vacancy 14 of the missing tooth and the first tooth from far right in FIG. 1A. In other words, when the tray 110 is worn on the portion of the patient's teeth 10, the vacancy 14 of the missing tooth and the first tooth 10 from far right in FIG. 1A is exposed out of the tray 110.

The connecting portion 117 is located at the exterior surface 114 of the main body 111. In the embodiment, the connecting portion 117 and the main body 111 are integrated. The connecting portion 117 and the main body 111 can be made in the same manufacturing process. Certainly, in other embodiments, the connecting portion 117 can be adhered, welded, clipped, screwed or engaged to the main body 111. In the embodiment, the connecting portion 117 includes a hook, but it is not limited thereto. In other embodiments, the connecting portion 117 may be a hole, an engaging member or a clip.

In some embodiments, the connecting portion 117 can be disposed on the buccal (cheek/lip) surface, the lingual (tongue/throat side), occlusal (top surface), mesial (facing the midline), distal (away from the midline) or anywhere on the exterior surface 114 of the tray 110 or combination depending on what is required for the brace 120. The connecting portion 117 can also be placed through the tray 110 such as a punch out hole, which will allow the brace 120 (such as a caplin hook or round button to attach a chain) on the buccal surface to help close off interproximal spaces and tighten up the dentition; while maintaining the teeth 10 within the arch form with the tray 110.

In addition, the main body 111 of the tray 110 includes at least one well 115 sunken from an interior surface 113 of the main body 111 for housing at least one attachment 12 or button which is attached to at least one of the portion of the patient's teeth 10. In the embodiment, a number of the at least one well 115 is two, a number of the at least one attachment 12 or button is two, but they are not limited thereto. When the tray 110 is worn on the portion of the teeth 10, the cooperation of the attachments 12 and the wells 115 can create the force(s)/pressure(s)/moments(s) to create osseous changes/osseous remodeling, which would then result in tooth/teeth movement.

In the embodiment, the tray 110 is transparent so as to provide esthetics, but the color of the tray 110 is not limited thereto. The tray 110 may be clear, translucent, any form of opacity or color. In addition, a material of the tray 110 is different from a material of the brace 120. The material of the tray 110 may be polyethylene terephthalate glycol (PeT-G), polypropylene (PP), polycarbonate (PC), thermoplastic polyurethanes (TPU), or ethylene-vinyl acetate (EVA). The material of the brace 120 may be metal or a combination of different metals, alloys, combination of metal alloys, resins, or a combination of resins, plastic or a combination of plastic, ceramic or rubber. Certainly, the materials of the tray 110 and the brace 120 are not limited thereto.

The brace 120 is detachably connected to the connecting portion 117. In the embodiment, the brace 120 is for being fixed to at least one of the patient's teeth 10 which is close to the portion which will be covered by the tray 110. As shown in FIG. 1B, when the tray 110 is worn on the portion of the teeth 10, the brace 120 extends to the connecting portion 117 and detachably connected to the connecting portion 117.

Specifically, the brace 120 includes at least one first member 122 and a second member 124 detachably connected to each other, the at least one first member 122 is fix to the at least one of the patient's teeth 10, and the second member 124 extends to the connecting portion 117 and detachably connected to the connecting portion 117. The brace 120 which includes the first member 122 and the second member 124 can snap on to the tray 110 instead of the actual tooth/enamel itself.

As shown in FIG. 1B, a number of the first member 122 is one, but it is not limited thereto. The first member 122 of the brace 120 includes a bracket, and the second member 124 of the brace 120 includes a wire. In some embodiments, the first member 122 of the brace 120 can include different types of molar uprighting appliances (fixed appliances bonded/banded to natural teeth 10), for example TADS (temporary anchorage devices such as implants) for better anchorage. The second member 124 of the brace 120 may include a tube, a sleeve, a hook, a band, a coil, a spring, a chain or an elastic.

In some embodiments, the second member 124 of the brace 120 can be a sleeve, a tube or a spring to maintain or open up the space for teeth replacement in the missing area. The second member 124 of the brace 120 can be a c-chain to help tighten up the contacts between the teeth 10 and tighten up the arch form. The second member 124 of the brace 120 can be elastics (rubber bands) use to help correct molar position and improve arch form. The second member 124 of the brace 120 can be a lingual button or a wire loop which assists with bite correction. The brace 120 can be wire and bracket on buccal (exterior surface 114) with lingual (tongue surface) arch holding wire to maintain the arch space to prevent collapse while moving the teeth 10.

In the embodiment, the second member 124 is connected to the first member 122 and extends through the vacancy 14 of the missing tooth to the third tooth from the far right in FIG. 1A. The second member 124 has an end 126 shaped as a hook. When the tray 110 is worn on the portion of the teeth 10, the end 126 of the second member 124 is hooked by the connecting portion 117.

Certainly, in some embodiments, the brace 120 may snap on/snap in/snap through/slide on/slide in/slide through/clip on/clip in/clip through/crimp on/crimp in/crimp through, adhere on/adhere in/adhere through/latch on/latch in/latch through/press on/press in/press through/twist on/twist in/twist through/bonded on/bonded in/bonded through/welded on via hot or cold/welded in via hot or cold, welded through via hot or cold, self-ligating to the connecting portion 117. Hence, the doctor(s)/clinician(s)/staff(s) to place their selection of the brace 120 onto the external surface of the tray 110.

In the conventional technique, if the user has the missing tooth, a part of the conventional clear aligners corresponding to the missing tooth serves as the connector to cover the vacancy of the missing tooth. However, the force(s)/pressure(s)/moments(s) created from one part of the clear aligners which is located at one side of the connector is difficult to transfer to the other part of the clear aligners which is located at the other side of the connector, so that the issue of the point of failure, poor seating, undercuts, point of flexibility, cross arch stabilization, or expansion/compression of the clear aligners occurs.

Comparing to the conventional clear aligners, the tray 110 of the hybrid orthodontic appliance 100 of the embodiment does not cover the vacancy 14 of the missing tooth, the brace 120 can be fixed to the tooth or the teeth 10 which are beside the vacancy 14 of the missing tooth and are not covered by the tray 110, and the brace 120 is connected to the tray 110 to provide or transfer the forces, pressure and/or moments to the tray 110, such that more stable tooth/teeth movement can be provided.

In addition, the tray 110 can be taken off to ensure proper hygiene, then place it back on to ensure proper teeth movement and outcome. The hybrid orthodontic appliance 100 can provide the advantages of both the tray 110 and the brace 120 so as to create better and more effective teeth movement on the premise of providing user convenience and comfort.

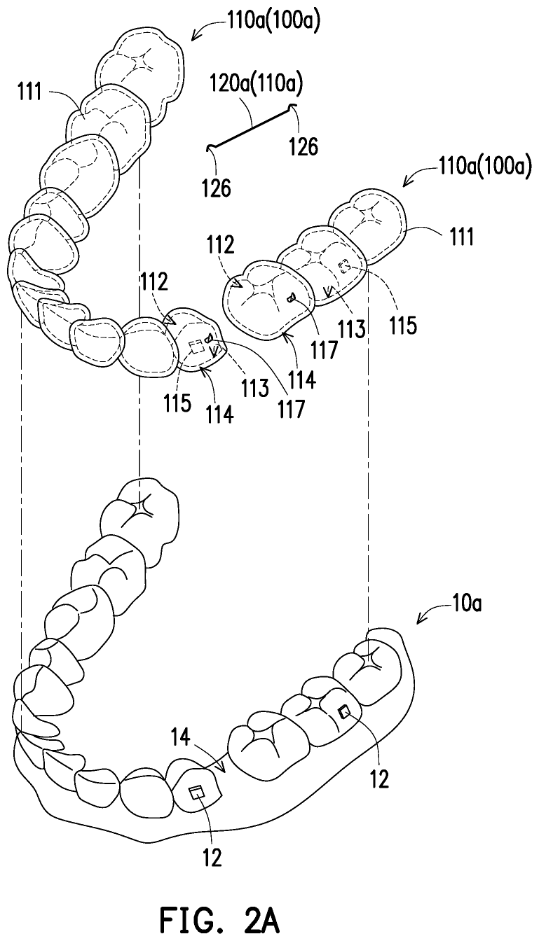

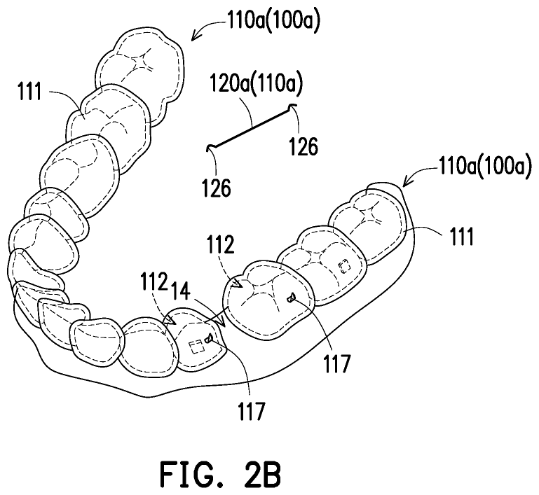

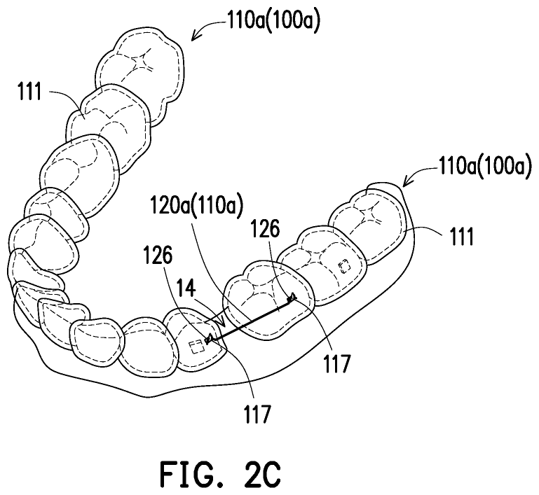

FIG. 2A is a schematic view of a hybrid orthodontic appliance according to another embodiment of the disclosure not worn on teeth yet. FIG. 2B is the trays of the hybrid orthodontic appliance of FIG. 2A worn on the teeth. FIG. 2C is the brace connected to the trays of the hybrid orthodontic appliance of FIG. 2B.

Referring to FIG. 2A to FIG. 2C, in the embodiment, the orthodontic appliance 100a includes a plurality of trays 110a and at least one brace 120a. The trays 110a are separated from each other, each of the at least one brace 120a is located between two adjacent trays 110a of the trays 110a. As shown in FIG. 2A, there is one missing tooth (the fourth tooth from the far right in FIG. 2A is missing), the teeth 10a are separated to two parts by the vacancy 14 of the missing tooth. In the embodiment, a number of the trays 110a is two, and a number of the at least one brace 120a is one, but the relationship of the trays 110a and the vacancy 14 and the numbers of the trays 110a and the brace 120a are not limited thereto.

Each of the trays 110a includes a main body 111 and a connecting portion 117 or multiple connecting portions if necessary. The main body 111 includes a tooth receiving cavity 112 shaped to receive only a portion of the patient's teeth 10a. The connecting portion 117 is located at an exterior surface 114 of the main body 111.

In the embodiment, the connecting portion 117 and the main body 111 of each of the trays 110a are integrated. The connecting portion 117 and the main body 111 can be made in the same manufacturing process. Certainly, in other embodiments, the connecting portion 117 can be adhered, welded, clipped, screwed or engaged to the main body 111. In the embodiment, the connecting portion 117 includes a hook, but it is not limited thereto. In other embodiments, the connecting portion 117 may be a hole, an engaging member or a clip.

In addition, the main body 111 of each of the trays 110a includes at least one well 115 sunken from an interior surface 113 of the main body 111 for housing at least one attachment 12 or button which is adapted to attach to at least one of the portion of the patient's teeth 10a. In the embodiment, a number of the at least one well 115 of each of the trays 110a is one, but it is not limited thereto. As shown in FIG. 2B, when the trays 110a are worn on the portions of the teeth 10a (the two parts of the teeth 10a separated by the vacancy 14), the cooperation of the well 115 of each of the trays 110a and the corresponding attachment 12 can create the force(s)/pressure(s)/moments(s) to create osseous changes/osseous remodeling, which would then result in tooth/teeth movement.

In the embodiment, the tray 110a is transparent so as to provide esthetics, but the color of the tray 110a is not limited thereto. In addition, a material of the tray 110a is different from a material of the brace 120a. The material of the tray 110a may be polyethylene terephthalate glycol (PeT-G), polypropylene (PP), polycarbonate (PC), thermoplastic polyurethanes (TPU), or ethylene-vinyl acetate (EVA). The material of the brace 120a may be metal, or a combination of different metals, alloys, combination of metal alloys, resins, or a combination of resins, plastic or a combination of plastic, ceramic or rubber. Certainly, the materials of the tray 110a and the brace 120a are not limited thereto.

The brace 120a includes two ends 126 opposite to each other, the two ends 126 of the brace 120a are connected to the connecting portions 117 of the two trays 110a, respectively. In the embodiment, the brace 120a may be a wire, and the two ends 126 of the brace 120a are shaped as hooks. As shown in FIG. 2C, the two ends 126 of the brace 120a can be hooked to the two connecting portions 117 of the two trays 110a so as to link the two trays 110a together and maintain or open up the space for teeth 10a replacement in the missing area. In other embodiments, the brace 120a may include a band, a coil, a spring, a chain, a hook or an elastic, the type of the brace 120a is not limited thereto.

The tray 110a of the hybrid orthodontic appliance 100 of the embodiment does not cover the vacancy 14 of the missing tooth, the brace 120a is connected to the trays 110a to transfer the forces, pressure and/or moments between the trays 110a so as to provide more stable tooth/teeth movement. In addition, the trays 110a can be taken off to ensure proper hygiene, then place them back on to ensure proper teeth movement and outcome. The hybrid orthodontic appliance 100 can provide the advantages of both the tray 110a and the brace 120a so as to create better and more effective teeth movement on the premise of providing user convenience and comfort.

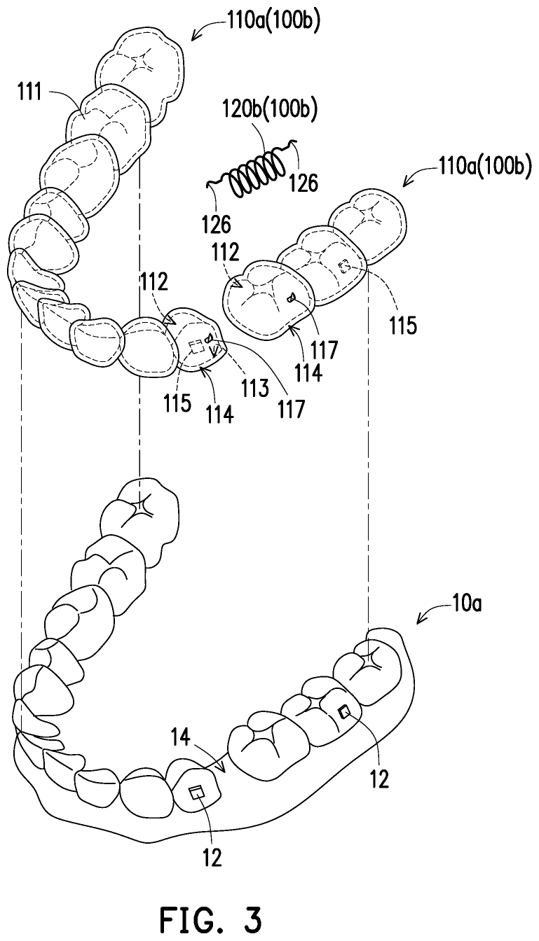

FIG. 3 is a schematic view of a hybrid orthodontic appliance according to another embodiment of the disclosure and teeth. Referring to FIG. 3, a main difference between the hybrid orthodontic appliance 100a of FIG. 2A and the hybrid orthodontic appliance 100b of FIG. 3 is that the type of the brace 120b in FIG. 3 is a spring, the brace 120b in FIG. 3 can open up or reduce the space for teeth 10 replacement in the missing area. Certainly, the type of the brace 120b is not limited thereto.

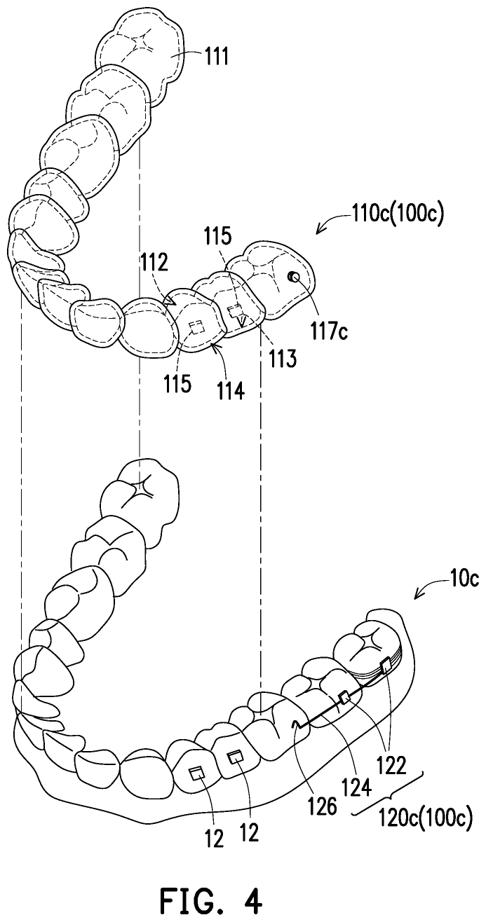

FIG. 4 is a schematic view of a hybrid orthodontic appliance according to another embodiment of the disclosure and teeth. Referring to FIG. 4, a main difference between FIG. 1A and FIG. 4 is that there is no missing tooth in the teeth 10c of FIG. 3. In other words, the hybrid orthodontic appliance 100c can be applied in the teeth 10c without missing tooth/teeth.

In the embodiment, the main body 111 of the tray 110c does not cover the two teeth 10c on the far right in FIG. 4. When the tray 110c is worn on the portion of the patient's teeth 10c, the two teeth 10c on the far right in FIG. 4 is exposed out of the tray 110c.

As shown in FIG. 4, a number of the first member 122 is two, but it is not limited thereto. Each of the first members 122 of the brace 120c includes a bracket, and the second member 124 of the brace 120c includes a wire. In other embodiment, the second member 124 of the brace 120c may include a hook, a band, a coil, a spring, a chain or an elastic.

In the embodiment, the type of the connecting portion 117c is different from the type of the connecting portion 117 of FIG. 1A, but the type of the connecting portion 117c is not limited thereto. The end 126 of the second member 124 of the brace 120c can be hooked or inserted into the connecting portion 117c. In other embodiments, the connecting portion 117 may be an engaging member or a clip.

Similarly, the brace 120c can be fixed to the teeth 10 which are not covered by the tray 110c, and the brace 120c can be connected to the tray 110c to provide the forces, pressure and/or moments to the tray 110c so as to provide more stable tooth/teeth movement. In addition, the tray 110c can be taken off to ensure proper hygiene, then place it back on to ensure proper teeth movement and outcome. The hybrid orthodontic appliance 100c can provide the advantages of both the tray 110c and the brace 120c so as to create better and more effective teeth movement on the premise of providing user convenience and comfort.

Every doctor(s)/dentist(s)/clinician(s)/staff(s) is trained differently with different philosophy and has different choices of material(s)/appliance(s)/equipment(s)/hardware etc. The hybrid orthodontic appliance will allow the treating person(s) to combine what they already have, to the tray of choice. They can incorporate the brace(s) and/or attachment(s) onto/into the trays via prescription/design, or they can attach as many hardware to the tray via specific attachment methods for the desired outcome. They can use what they have at their disposal and incorporate what they see fit for the desired outcome of treatment. In the future, a library of orthodontic/dental equipment/instruments/supplies etc. can be used to incorporate with the trays.

The treating person(s) can choose the desired time frame to incorporate the hybrid orthodontic appliance as it is up to them on when to place the braces or attachments and how to place the braces or attachments to ensure proper patient compliance and outcome. The time can be at the beginning of treatment, middle of treatment, end of treatment and/or any combination. This hybrid orthodontic appliance will solve other issues of changing dentition such as exfoliating primary dentition, mixed dentition for children, erupting dentitions, missing teeth such as canines, young adults with erupting second molars, missing teeth with implant planning for replacements, etc. This allows for better planning of treatment and less waste of material and time on tray fabrication/revisions.

With this hybrid orthodontic appliance, the patients can be taught how to take off the tray to ensure proper hygiene, then place it back on to ensure proper teeth movement and outcome. This reduces plaque buildup on appliances secured to natural teeth as well as demineralization of natural teeth due to the difficulty of homecare versus the conventional braces (traditional wires and brackets).

The hybrid orthodontic appliance can be used for molar uprighting/spacing/expansion/root angulation/individualizing teeth and positioning teeth for pre-prosthetic work. An example of this would be to create space for small teeth, which will require veneer(s)/crown(s)/restoration(s) to widen/lengthen/thicken to their natural dentition; or replace congenitally missing teeth due to tooth/size/space discrepancies.

The hybrid orthodontic appliance can incorporate multiple braces and/or attachments via any of the described method (and or combination of methods) via any position (and or combination of positions) for desired movements. For example, the clinician can attach a fixed first member of the brace to create a point of rotation or pivoting point, and a second member (spring) of the brace to create the movement, preventing the tooth from tipping. This can also be placed both buccal and lingual to prevent twisting/warping or improper tipping along the improper axis etc.

The hybrid orthodontic appliance of connecting the brace (such as a bracket, a band, a coil, a spring, a chain, a hook or an elastic) to the exterior surface of the tray to improve the qualities. By applying the above concepts this will better serve the community and push for integration of materials and methods to effectively and efficiently resolve problems that the community has faced. The hybrid orthodontic appliance is to improve on what is out there and be forward thinking to reduce time spent on/in treatment and to improve and lower the cost of treatment with a much better outcome, rather than accepting a compromise in treatment.

In summary, a hybrid orthodontic appliance according to the embodiments of the disclosure incorporates at least one tray and a brace. The connecting portion of the tray is located at the exterior surface of the main body. The brace is detachably connected to the connecting portion of the tray. In a hybrid orthodontic appliance according to the embodiments of the disclosure, the brace may be fixed to one of the patient's teeth which is close to the portion of the patient's teeth received by the tooth receiving cavity of the tray, and the brace extends to the connecting portion and detachably connected to the connecting portion of the tray. In a hybrid orthodontic appliance according to the embodiments of the disclosure, the brace may be located between two adjacent trays, and each of the two ends of the brace is connected to the connecting portion of the corresponding tray. That is, the two adjacent trays are connected by the brace, and the brace is connected to the trays instead of the actual tooth/enamel itself. Therefore, in the hybrid orthodontic appliances according to the embodiments of the disclosure above, the brace can provide or transfer the forces, pressure and/or moments to the tray or the trays, such that more stable tooth/teeth movement can be provided. In addition, the tray or the trays can be taken off to ensure proper hygiene, then place it/them back on to ensure proper teeth movement and outcome. The hybrid orthodontic appliance can provide the advantages of both the tray and the brace so as to create better and more effective teeth movement on the premise of providing user convenience and comfort.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A hybrid orthodontic appliance for repositioning a patient's teeth, the hybrid orthodontic appliance comprising:
at least one tray, wherein each of the at least one tray comprises:
a main body, comprising a tooth receiving cavity shaped to receive only a portion of the patient's teeth, an interior surface facing towards the tooth receiving cavity, and an exterior surface opposite to the interior surface; and
a connecting portion, located at the exterior surface of the main body; and
a brace detachably connected to the connecting portion.

2. The hybrid orthodontic appliance according to claim 1, wherein the brace comprises a first member and a second member connected to each other, the first member is for being fixed to one of the patient's teeth which is close to the portion, and the second member extends to the connecting portion and detachably connected to the connecting portion.

3. The hybrid orthodontic appliance according to claim 2, wherein the first member of the brace comprises a bracket, and the second member of the brace comprises a tube, a sleeve, a hook, a wire, a band, a coil, a spring, a chain or an elastic.

4. The hybrid orthodontic appliance according to claim 1, wherein the at least one tray comprises two trays, the brace comprises two ends opposite to each other, the brace is located between the two trays, and each of the two ends is connected to the connecting portion of the corresponding tray.

5. The hybrid orthodontic appliance according to claim 4, wherein the brace comprises a wire, a tube, a sleeve, a band, a coil, a spring, a chain, a hook or an elastic.

6. The hybrid orthodontic appliance according to claim 1, wherein the main body comprises a well sunken from the interior surface for housing an attachment which is adapted to attach to one of the portion of the patient's teeth.

7. The hybrid orthodontic appliance according to claim 1, wherein the connecting portion and the main body are integrated.

8. The hybrid orthodontic appliance according to claim 1, wherein the connecting portion comprises a hook, an engaging member, a hole or a clip.

9. A hybrid orthodontic appliance for repositioning a patient's teeth, the orthodontic appliance comprising:
a tray, comprising:
a main body, comprising a tooth receiving cavity shaped to receive only a portion of the patient's teeth; and
a connecting portion, located at an exterior surface of the main body; and
a brace for being fixed to one of the patient's teeth which is close to the portion, wherein the brace extends to the connecting portion and detachably connected to the connecting portion.

10. The hybrid orthodontic appliance according to claim 9, wherein the brace comprises a first member and a second member detachably connected to each other, the first member is fix to the one of the patient's teeth, and the second member extends to the connecting portion and detachably connected to the connecting portion.

11. The hybrid orthodontic appliance according to claim 10, wherein the first member of the brace comprises a bracket, and the second member of the brace comprises a tube, a sleeve, a hook, a wire, a band, a coil, a spring, a chain or an elastic.

12. The hybrid orthodontic appliance according to claim 9, wherein the main body comprises a well sunken from an interior surface of the main body for housing an attachment which is adapted to attach to one of the portion of the patient's teeth.

13. The hybrid orthodontic appliance according to claim 9, wherein the connecting portion and the main body are integrated.

14. The hybrid orthodontic appliance according to claim 9, wherein the connecting portion comprises a hook, an engaging member, a hole or a clip.

15. A hybrid orthodontic appliance for repositioning a patient's teeth, the orthodontic appliance comprising:
a plurality of trays, separated from each other, wherein each of the trays comprises:
a main body, comprising a tooth receiving cavity shaped to receive only a portion of the patient's teeth; and
a connecting portion, located at an exterior surface of the main body; and
at least one brace, wherein each of the at least one brace comprises two ends opposite to each other, each of the at least one brace is located between two adjacent trays of the trays, and each of the two ends of the brace is connected to the connecting portion of the corresponding tray.

16. The hybrid orthodontic appliance according to claim 15, wherein the brace comprises a wire, a tube, a sleeve, a band, a coil, a spring, a chain, a hook or an elastic.

17. The hybrid orthodontic appliance according to claim 15, wherein the connecting portion and the main body are integrated.

18. The hybrid orthodontic appliance according to claim 15, wherein the connecting portion comprises a hook, an engaging member, a hole or a clip.

19. The hybrid orthodontic appliance according to claim 15, wherein the main body comprises a well sunken from an interior surface of the main body for housing an attachment which is adapted to attach to one of the portion of the patient's teeth.

20. The hybrid orthodontic appliance according to claim 15, wherein the trays are transparent, and a material of the trays is different from a material of the at least one brace.
